(19) United States
(12) Patent Application Publication
(10) Pub. No.: US 2008/0274070 A1
(43) Pub. Date: Nov. 6, 2008

(54) Method for permanently reshaping keratin fibers comprising applying a poorly concentrated reducing compositions followed by drying

(76) Inventors: Catherine Campain, Paris (FR); Katia Dutheil-Gouret, Plaisir (FR); Gaelle Petit, Paris (FR); Francoise Gevaudan, Beauchamp (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/003,321

(22) Filed: Dec. 21, 2007

Related U.S. Application Data
(60) Provisional application No. 60/907,509, filed on Apr. 5, 2007.

(30) Foreign Application Priority Data
Dec. 22, 2006 (FR) 0655931

(51) Int. Cl. A61Q 5/04

(52) U.S. Cl. 424/70.2

(57) ABSTRACT

The present disclosure relates to a method for permanently reshaping the keratin fibers, for example permanently reshaping the hair, comprising:
setting the keratin fibers under tension, then
applying a reducing composition onto the keratin fibers so as to reduce the keratin disulfide bonds, said reducing composition comprising in a cosmetically acceptable medium from 0.1 to 3% by weight of at least one reducing agent, as relative to the total weight of the reducing composition, then, after an optional rinsing operation,
drying the keratin fibers, then
oxidation fixing, so as to reform said bonds, by applying an oxidizing composition onto the keratin fibers.

This application claims benefit of U.S. Provisional Application No. 60/907,509, filed Apr. 5, 2007, the contents of which are incorporated herein by reference. This application also claims benefit of priority under 35 U.S.C. § 119 to French Patent Application No. FR 0 655 931, filed Dec. 22, 2006, the contents of which are also incorporated herein by reference.

The present disclosure relates to a method for permanently reshaping keratin fibers, such as the hair, comprising applying a poorly concentrated reducing composition to the fibers, followed by drying the fibers and then applying an oxidizing composition to the dried fibers.

Many products are marketed to easily style, texturize and add some weight to the hair, for instance thin hair, with products such as foams, styling gels and hair lacquers. These products may enable shaping of the hair but are removed with shampoo and thus require re-application on an every day-basis.

It is known that long-lasting deformation of the hair can be obtained by opening the keratin S—S disulfide bonds (cystine) with a composition comprising a suitable reducing agent (reducing step) in a first step, followed by, once the thus treated hair has been rinsed, generally with water, reforming in a second step the disulfide bonds, by applying onto the hair which has been placed beforehand under tension, using curlers for example, an oxidizing composition (oxidizing step, also called fixing step) so as to give the hair the expected form in the end. These steps are generally conducted by maintaining the keratin fibers under a mechanical stress, for example curlers.

The new shape that is imposed to the hair by means of a chemical treatment such as described above, may be temporally long-lasting and may be resistant to washing operations with water or shampoo, as opposed to known simple methods for temporarily reshaping the hair by using foams, styling gels or lacquers.

However, winding up curlers is a technical gesture that non experienced consumers may find difficult to perform. Accordingly, methods have been developed that omit this step, comprising setting the hair under tension with curlers, so as to control the hair shape.

However, because such methods do not use curlers, they may not provide the hair with a strong tensioning and the hair shape that is thus obtained may be both rather moderate and relatively short-lived.

As a further drawback, the usual methods to permanently reshape the hair, as described above, which typically require using high contents of thioglycolic acid or a salt thereof, may affect the color of an artificially colored hair.

Thus, for example, when the methods for permanently reshaping the hair described above are applied to hair having beforehand undergone an artificial hair coloring, they may cause degradation or stripping action of the artificial color.

Thus, the known methods for permanently reshaping keratin fibers such as the hair do not always lead to a fully satisfying permanently reshaping method with regard to one or more of the drawbacks mentioned above.

Therefore, there is a need in the art and in the marketplace for a method for permanently reshaping keratin fibers such as the hair, that does not affect artificial hair color, and/or that makes it possible to durably perform a hair volume expansion, both at the root level by lifting the same, but also along the whole length. Moreover, this method ideally would be efficient for short-length and thin hair and provide an improved stylability with an easy to set material.

The present inventors have discovered a method for permanently reshaping keratin fibers comprising applying a poorly concentrated reducing composition to the keratin fibers, drying the fibers, and then carrying out oxidation fixing.

In at least one embodiment, therefore, the present disclosure relates to a method for permanently reshaping the keratin fibers, for example hair keratin fibers, comprising:
setting the keratin fibers under tension, then
applying a reducing composition onto the keratin fibers, so as to reduce the keratin disulfide bonds, said reducing composition comprising in a cosmetically acceptable medium, from 0.1 to 3% by weight of at least one reducing agent, by weight relative to the reducing composition total weight, then, after an optional rinsing operation,
drying the keratin fibers, then
carrying out oxidation fixing, so as to reform said bonds, by applying an oxidizing composition onto the keratin fibers.

Applying a poorly concentrated reducing composition onto the keratin fibers is intended to ensure that the keratin fibers will be preserved, for instance, on colored hair. In at least one embodiment, a protecting effect on artificially colored hair may be observed both during the implementation of the method disclosed herein, and after, upon repeated washing with shampoos. In at least one embodiment, the method for permanently reshaping the keratin fibers disclosed herein does not deteriorate the artificial hair color.

Applying onto the keratin fibers a poorly concentrated reducing composition also makes it possible for the presently disclosed method to be carried out many times and temporally at close intervals onto the same keratin fibers, without damaging them, which is usually not possible with methods employing more concentrated reducing agents.

Applying onto the keratin fibers a poorly concentrated reducing composition may further enable a reduction of off-odors that may be released as compared to the traditional shaping methods.

Applying onto the keratin fibers a poorly concentrated reducing composition may also allow for varying reaction times on the hair depending on the nature of the hair, and may not require a change of reducing composition type depending on the hair type to be treated. This may be beneficial for the ordinary consumer, as it may not be necessary to choose amongst several reducing composition types depending on the nature of the hair, but only to vary its reaction time.

As disclosed herein, the keratin fiber tensioning may be performed using any means, for example hair elastics, clips, combs, slides, foam rollers and “tulip-type” curlers.

In at least one embodiment of the present disclosure, tulip-type curlers are used. Tulip-type curlers consist of a body-forming extended rod, ending at one end with a head provided with at least one hole. The curler body is made in a supple and flexible material, so that its free end may be introduced into the head hole and be maintained there by an elastic clamping. A curler of this type is described, for instance, in French Patent Application No. 2 602 650.

Using a tulip-type curler makes it possible to control the tension applied onto the hair and thus give a rounded form to hair strands during the treatment time, without excessively pulling the hair, as opposed to what may happen with most cylindrical curlers. Tulip-type curlers may also be easy to set and more comfortable for the scalp, as compared to traditional cylindrical curlers. Depending on the hair shape and on the expected curl volume, the winding up may be carried out on less thick hair strands.

The method as disclosed herein comprises drying the keratin fibers after the poorly concentrated reducing composition has been applied. Drying the keratin fibers may involve a partial drying or a complete drying, and may be carried out by a domestic hair dryer or a hood hair dryer or a heating hair cap, or the hair may also be air dried, after it has been carefully wrung out. In at least one embodiment of the present disclosure, the keratin fiber drying is a complete drying. In at least one embodiment, a heating device is used to dry the hair.

The reducing composition used in the method according to the present disclosure, comprises, in a cosmetically acceptable medium, at least one reducing agent chosen from sulfites, bisulfites, thiols and phosphines.

Non-limiting examples of sulfites and bisulfites that may be used include alkaline metals, alkaline-earth metals, ammonium sulfites and bisulfites, for example sodium, potassium, monoethanol amine sulfite and bisulfite.

In at least one embodiment of the present disclosure, the thiol(s) used as the at least one reducing agent in the reducing composition may be chosen from, but are not limited to, cysteine and derivatives thereof, such as N-acetylcysteine, cysteamine and derivatives thereof, such as C₁-C₄ acyl derivatives thereof, such as N-acetyl cysteamine and N-propionyl cysteamine, thiolactic acid and esters thereof, such as glycerol monothiolactate, thioglycolic acid and esters thereof, such as glycerol or glycol monothioglycolate, and thioglycerol.

Other suitable examples of thiols that may be used in the reducing composition include, but are not limited to sugar N-mercapto alkyl amides, such as N-(mercapto-2-ethyl)gluconamide, β-mercaptopropionic acid and derivatives thereof, thiomalic acid, pantheteine, N-(mercaptoalkyl)ω-hydroxyalkyl amides, such as those described in European Patent Application No. 0 354 835 and N-mono- or N,N-dialkylmercapto 4-butyramides, such as those described in European Patent Application No. 0 368 763, aminomercaptoalkyl amides, such as those described in European Patent Application No. 0 432 000 and alkylaminomercaptoalkylamides, such as those described in European Patent Application No. 0 514 282, (2/3) hydroxy-2 propyl thioglycolate and, hydroxy-2 methyl-1 ethyl thioglycolate-based mixture (67/33) described in French Patent Application No. 2 679 448.

The present inventors have demonstrated that by applying a cysteine-containing reducing composition, hair volume expansion may be obtained, both at the root level by lifting the same, but also along the whole hair length, on short-length and thin hair as well.

In at least one embodiment, the at least one reducing agent may be chosen from L-cysteine, D-cysteine, L,D-cysteine, and their salts, thiolactic acid, salts and esters thereof, thioglycolic acid, salts and esters thereof, and mixtures thereof.

In a further embodiment, the at least one reducing agent is cysteine.

As disclosed herein, the at least one reducing agent may be present in the reducing composition in an amount ranging from 0.3 to 3% by weight, relative to the total weight of the reducing composition.

According to at least one embodiment, the reducing composition may be allowed to react for 1 to 50 minutes, for example for 1 to 30 minutes. The reaction time of the reducing composition will be changed depending on the nature of the hair.

During or after application of the reducing composition, the keratin fibers may be submitted to a thermal treatment by heating, for example to a temperature ranging from 30 to 250° C. for part of or all the reaction time as defined above. The thermal treatment may be conducted by means of a hood hair dryer, a hair dryer, a round iron, a flat iron, an IR-emitting device and other heating devices, and in some cases under a plastic film.

The pH value of the reducing composition according to the present disclosure, may range from 7.5 to 11, for example from 8 to 9.5.

The pH value of the reducing composition of the present disclosure may be traditionally obtained and/or adjusted by adding either alkaline agents, such as ammonia, monoethanol amine, diethanol amine, triethanol amine, isopropanol amine, 2-methyl-2-amino-1-propanol, propanediamine-1,3, alkaline or ammonium carbonate or bicarbonate, sodium carbonate and bicarbonate, an organic carbonate, such as guanidine carbonate, or alkaline hydroxide, wherein all these compounds may be used either alone or in combination, or acidifying agents, such as hydrochloric acid, acetic acid, lactic acid, boric acid, citric acid and phosphoric acid.

According to the present disclosure, the reducing composition used herein may also comprise at least one cosmetic active agent to improve the cosmetic properties of the hair fibers or to reduce or prevent their damage.

The at least one cosmetic active agent may be chosen from, but not limited to volatile or non volatile, linear or cyclic, amine-type or not, silicones, cationic, anionic, non ionic or amphoteric polymers, peptides and derivatives thereof, protein hydrolyzates, synthetic or natural waxes, for example fatty alcohols, swelling agents and penetrating agents or agents intended to improve the efficiency of the at least one reducing agent, as well as other active compounds, such as anionic, cationic, non ionic, amphoteric or zwitterionic surfactants, agents for combating hair loss, anti-dandruff agents, associative or non-associative, natural or synthetic thickeners, suspending agents, sequestering agents, opacifying agents, dyes, sunscreen agents, fillers, vitamins or provitamins, mineral, vegetable or synthetic oils, as well as fragrances, preserving agents, stabilizers, and mixtures thereof.

In at least one embodiment, the reducing composition may comprise a cationic polymer and/or at least one silicone.

As used herein, a “cationic polymer” is understood to mean any polymer comprising cationic groups or groups ionizable to cationic groups.

Examples of cationic polymers include, but are not limited to those which comprise units containing primary, secondary, tertiary and/or quaternary amine groups, that may either belong to the polymer main chain, or be carried by a side substituent that is directly bound to it.

Cationic polymers that are used according to the present disclosure have a number average molecular weight ranging from about 500 to 5.10⁶, for example from about 10³ to 3.10⁶.

In at least one embodiment, the cationic polymers encompass polyamine, polyaminoamide and quaternary polyammonium type polymers.

Cationic polymers, as defined above, are described, for instance, in French Patent Nos. 2 505 348 and 2 542 997. Such polymers include:

(1) homopolymers or copolymers derived from acrylic or methacrylic esters or amides and comprising at least one of the units of following formulas (I), (II), (III) or (IV):

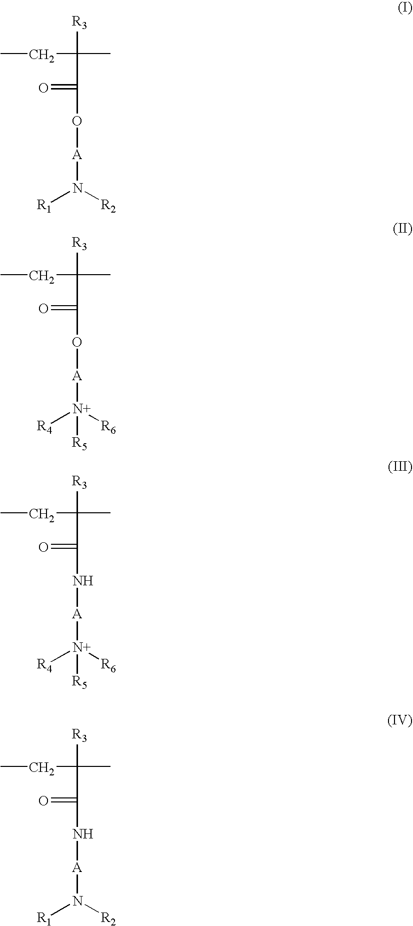

wherein:

R₃, which may be identical or different, are chosen from hydrogen atoms and CH₃ radicals;

A, which may be identical or different, are chosen from linear or branched C₁-C₆ alkyl groups, for example C₂-C₃ alkyl groups, and from hydroxy(C₁-C₄)alkyl groups;

R₄, R₅, R₆, which may be identical or different, are chosen from C₁-C₁₈ alkyl groups and benzyl radicals, for example C₁-C₆ alkyl groups;

R₁ and R₂, which may be identical or different, are chosen from hydrogen and C₁-C₆ alkyl groups, for example methyl or ethyl groups;

X is an anion derived from a mineral organ organic acid, such as a methosulfate anion or a halide, such as chloride and bromide.

Polymers of family (1) may additionally comprise at least one unit derived from comonomers that may be chosen from, but are not limited to acrylamides, methacrylamides, diacetone acrylamides, acrylamides and methacrylamides substituted on the nitrogen atom with a lower (C₁-C₄)alkyl group, acrylic or methacrylic acids or esters thereof, vinyl lactames, such as vinyl pyrrolidone or vinyl caprolactame, and vinyl esters.

Thus, these polymers of family (1) may encompass:
copolymers of acrylamide and dimethyl aminoethyl methacrylate quaternized with dimethyl sulfate or dimethyl halide, such as the one marketed under the name HERCOFLOC by HERCULES,
copolymers of acrylamide and methacryloyloxyethyl trimethylammonium chloride described, for example in European Patent Application No. EP-A-080 976 and marketed under the name BINA QUAT P 100 by CIBA GEIGY,
copolymer of acrylamide and methacryloyloxyethyl trimethylammonium methosulfate marketed, for instance under the name RETEN by HERCULES,
copolymers of vinyl pyrrolidone and dialkylaminoalkyl acrylate or methacrylate, optionally quaternized, such as products marketed under the name “GAFQUAT” by ISP, for example “GAFQUAT 734” or “GAFQUAT 755” or products called “COPOLYMER 845, 958 and 937”. These polymers are described in detail in French Patent Nos. 2 077 143 and 2 393 573,
terpolymers of dimethylaminoethyl methacrylate, vinyl caprolactame and vinyl pyrrolidone, such as the product marketed under the name GAFFIX VC 713 by ISP,
copolymers of vinyl pyrrolidone and methacrylamidopropyl dimethyl amine marketed, for example under the trade name STYLEZE CC 10 by ISP,
and quaternized copolymers of vinyl pyrrolidone and dimethylaminopropyl methacrylamide, such as the product marketed under the name “GAFQUAT HS100” by ISP.

(2) Cellulose ether derivatives comprising quaternary ammonium groups, as described in French Patent No. 1 492 597, and polymers marketed under the trade names “JR” (JR 400, JR 125, JR 30M) or “LR” (LR 400, LR 30M) by Union Carbide Corporation. These polymers are defined, for instance in the CTFA dictionary as being hydroxyethylcellulose quaternary ammonium compounds having reacted with an epoxide substituted with a trimethylammonium group.

(3) Cationic cellulose derivatives, such as copolymers of cellulose or cellulose derivatives graft with a quaternary ammonium hydrosoluble monomer, and described, for instance in U.S. Pat. No. 4,131,576, such as hydroxyalkyl celluloses, for example hydroxymethyl-, hydroxyethyl- or hydroxypropyl celluloses graft with a methacryloylethyl trimethylammonium, methacrylmidopropyl trimethylammonium, or a dimethyl diallylammonium salt.

The products as described above are available, for example, as products marketed under the name “Celquat L 200” and “Celquat H 100” by National Starch.

(4) Cationic polysaccharides described, for instance in U.S. Pat. Nos. 3,589,578 and 4,031,307, such as guar gums comprising trialkylammonium cationic groups, for example guar gums modified with a 2,3-epoxypropyl trimethylammonium (e.g. chloride) salt.

Such products are marketed, for example under the trade names JAGUAR C13 S, JAGUAR C 15, JAGUAR C 17 or JAGUAR C162 by MEYHALL.

(5) Polymers comprising piperazinyl units and alkylene or hydroxyalkylene divalent radicals with straight or branched chains, optionally interrupted with oxygen, sulfur, or nitrogen atoms or with aromatic or heterocyclic rings, as well as oxidation products and/or quaternization products of these polymers. Such polymers are described, for example in French Patent Nos. 2 162 025 and 2 280 361.

(6) Water-soluble polyaminoamides prepared by polycondensing an acidic compound with a polyamine; these polyaminoamides may be crosslinked with a epihalohydrine, a diepoxide, a dianhydride, an unsaturated dianhydride, a bis-unsaturated derivative, a bis-halohydrine, a bis-azetidinium, a bis-haloacyidiamine, an alkyl bis-halide or with an oligomer resulting from the reaction of a bifunctional compound reactive against a bis-halohydrine, a bis-azetidinium, a bis-haloacyldiamine, an alkyl bis-halide, an epilhalohydrine, a diepoxide or a bis-unsaturated derivative; the crosslinking agent being present in an amount ranging from 0.025 to 0.35 mole per amine group of the polyaminoamide; these polyaminoamides may be alkylated or, in the event they have one or more tertiary amine function(s), quaternized. Such polymers are described in French Patent Nos. 2 252 840 and 2 368 508.

(7) Polyaminoamide derivatives resulting from the condensation of polyalkylene polyamines with polycarboxylic acids, followed with an alkylation with bifunctional agents. Non-limiting examples include polymers of adipic acid and dialkylaminohydroxyalkyl dialkylene triamine, wherein the alkyl radical comprises from 1 to 4 carbon atoms, for example methyl, ethyl or propyl. Such polymers are described, for instance in French Patent No. 1 583 363.

By way of non-limiting example, polymers of adipic acid, dimethylaminohydroxypropyl and diethylene triamine marketed, for instance under the name “Cartaretine F, F4 or F8” by Sandoz, may be described.

(8) Polymers obtained by reacting a polyalkylene polyamine comprising two primary amine groups and at least one secondary amine group with a dicarboxylic acid chosen from diglycolic acid and saturated aliphatic dicarboxylic acids comprising from 3 to 8 carbon atoms. The molar ratio of the polyalkylene polyamine to the dicarboxylic acid may range from 0.8:1 to 1.4:1; the resulting polyaminoamide being reacted with epichlorhydrine according to a molar ratio of epichlorhydrine to secondary amine group of the polyaminoamide ranging from 0.5:1 to 1, 8:1. Such polymers are described, for example in U.S. Pat. Nos. 3,227,615 and 2,961,347.

Such polymers may be marketed, for example under the trade name “Hercosett 57” by Hercules Inc. or under the trade name “PD 170” or “Delsette 101” by Hercules in the case of the copolymer of adipic acid, epoxypropyl and diethylene triamine.

(9) Cyclopolymers of alkyl diallyl amine or dialkyl diallyl ammonium, such as homopolymers or copolymers comprising as a main substituent of the chain units of formulas (V) or (VI):

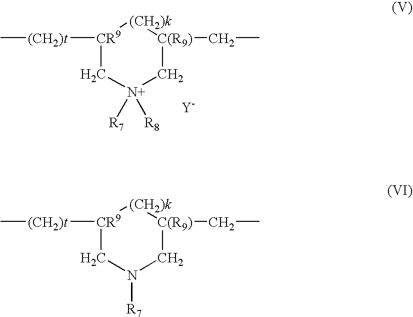

wherein k and t are 0 or 1, the sum k+t equal to 1; R₉ is a hydrogen atom or a methyl radical; R₇ and R₈, independently of each other, may be chosen from C₁-C₂₂ alkyl groups, hydroxy(C₁-C₅)alkyl groups, and lower amido(C₁-C₄)alkyl groups, or R₇ and R₈ may form together with the nitrogen atom to which they are bound, heterocyclic groups, such as piperidinyl or morpholinyl; in at least one embodiment, R₇ and R₈ independently of each other, are C₁-C₄ alkyl groups; Y⁻ is an anion, such as bromide, chloride, acetate, borate, citrate, tartrate, bisulfate, bisulfite, sulfate, and phosphate. Such polymers are described, for example in French Patent No. 2 080 759 and in its Certificate of Addition No. 2 190 406.

Non-limiting examples of the previously defined polymers include the dimethyldiallylammonium chloride homopolymer marketed under the name “Merquat 100” by Calgon (as well as its homologues having a low weight average molecular weight) and copolymers of diallyldimethylammonium chloride and acrylamide marketed under the trade name “MERQUAT 550”.

(10) the diquaternary ammonium polymer comprising repeating units of the following formula (VII):

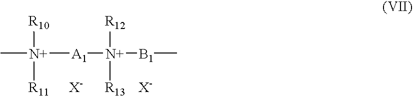

wherein:
R₁₀, R₁₁, R₁₂ and R₁₃, which are identical or different, may be chosen from aliphatic, alicyclic, or aryl aliphatic radicals comprising from 1 to 20 carbon atoms and lower hydroxyalkyl aliphatic radicals, or R₁₀, R₁₁, R₁₂ and R₁₃, taken together or separately, may form together with the nitrogen atoms to which they are bound heterocycles, optionally comprising a second heteroatom different from nitrogen or R₁₀, R₁₁, R₁₂ and R₁₃ may be chosen from linear or branched, C₁-C₆ alkyl radicals, substituted with a nitrile, ester, acyl, amide or —CO—O—R₁₄-D or —CO—NH₁₄-D group, wherein R₁₄ is an alkylene and D is a quaternary ammonium group;

A1 and B1 are C₂-C₂₀ polymethylene groups that may be linear or branched, saturated or unsaturated, and that may comprise, bound to or inserted within the main chain, at least one aromatic ring, or at least one oxygen or sulfur atom(s), or sulfoxide, sulfone, disulfide, amino, alkylamino, hydroxyl, quaternary ammonium, ureido, amide or ester group, and

X⁻ is an anion derived from a mineral or an organic acid;

A1, R₁₀ and R₁₂ may form together with the two nitrogen atoms to which they are bound a piperazine ring; moreover, if A1 is a linear or branched, saturated or unsaturated alkylene or hydroxyalkylene radical, B1 may also be a —(CH₂)n-CO-D-OC—(CH₂)n- group, wherein D is:

a) a glycol residue of formula: —O-Z-O—, wherein Z is a linear or branched hydrocarbon radical or a group having one of the following formulas:

—(CH₂—CH₂—O)x—CH₂—CH₂—

—[CH₂—CH(CH₃)—O]y—CH₂—CH(CH₃)—

wherein x and y are integers ranging from 1 to 4, corresponding to a defined and unique polymerization degree, or any number from 1 to 4 corresponding to a medium polymerization degree;

b) a bis-secondary diamine residue, such as a piperazine derivative;

c) a bis-primary diamine residue of formula: —NH—Y—NH—, wherein Y is a linear or branched hydrocarbon radical, or the bivalent radical

—CH₂—CH₂—S—S—CH₂—CH₂—;

d) a ureylene group of formula: —NH—CO—NH—.

In at least one embodiment, X⁻ is an anion, such as chloride or bromide.

According to the present disclosure, such polymers may have a number average molecular weight ranging from 1000 to 100000.

Such polymers are described, for example in French Patent Nos. 2 320 330, 2 270 846, 2 316 271, 2 336 434 and 2 413 907, and in U.S. Pat. Nos. 2,273,780, 2,375,853, 2,388,614, 2,454,547, 3,206,462, 2,261,002, 2,271,378, 3,874,870, 4,001,432, 3,929,990, 3,966,904, 4,005,193, 4,025,617, 4,025,627, 4,025,653, 4,026,945 and 4,027,020.

According to at least one embodiment, polymers that comprise repeating units of following formula (VII) may be used:

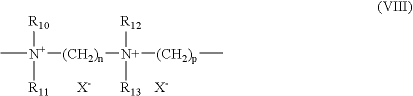

wherein R₁₀, R₁₁, R₁₂ and R₁₃, which may be identical or different, are alkyl radicals or hydroxyalkyl radicals comprising from 1 to 4 carbon atoms; n and p are integers ranging from 2 to 20; and X⁻ is an anion derived from a mineral or an organic acid. In at least one embodiment, hexadimethrine chloride (INCI name), marketed by CHIMEX under the reference MEXOMERE POLYMERE D'OLEFIN may be mentioned by way of non-limiting example;

(11) Quaternary polyammonium compounds comprising repeating units of formula (IX):

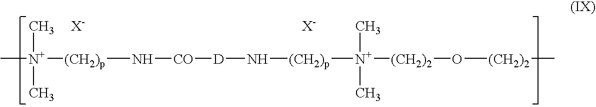

wherein p is an integer ranging from 1 to 6; D may be zero or may be a —(CH₂)ᵣ—CO— group, wherein r is a number equal to 4 or 7; and X⁻ is an anion;

Such polymers may be prepared according to methods described in U.S. Pat. Nos. 4,157,388, 4,702,906 and 4,719,282. Such polymers are described, for instance in European Patent Application 0 122 324.

Suitable examples of such polymers include, but are not limited to products sold by Miranol, for example “Mirapol A 15”, “Mirapol AD1”, “Mirapol AZ1” and “Mirapol 175”.

(12) Quaternary polymers of vinyl pyrrolidone and vinyl imidazole, such as the products marketed under the trade names Luviquat FC 905, FC 550 and FC 370 by BASF.

(13) Polyamines, such as Polyquart H sold by HENKEL, under the reference “POLYETHYLENE GLYCOL (15) TALLOW POLYAMINE” in the CTFA dictionary.

(14) Crosslinked polymers of methacryloyloxyalkyl(C₁-C₄) trialkyl(C₁-C₄)ammonium salts, such as polymers obtained by homopolymerizing the dimethylaminoethyl methacrylate quaternized with methyl chloride, or by copolymerizing the acrylamide with dimethylaminoethyl methacrylate quaternized with methyl chloride, wherein the homo- or copolymerization is followed by crosslinking with an olefinically unsaturated compound, for example methylene bis acrylamide. A crosslinked copolymer of acrylamide and methacryloyloxyethyl trimethylammonium chloride (20:80 by weight) may be used, in at least one embodiment, in the form of a dispersion comprising 50% by weight of said copolymer in mineral oil. Such dispersion is marketed, for instance under the trade name “SALCARE® SC 92” by ALLIED COLLOIDS. A crosslinked homopolymer of methacryloyloxyethyl trimethylammonium chloride may also be used, comprising about 50% by weight of said homopolymer in mineral oil or in a liquid ester. Such dispersions are marketed, for example under the trade names “SALCARE® SC 95” and “SALCARE® SC 96” by ALLIED COLLOIDS.

Other useful cationic polymers according to the present disclosure are polyalkylene imines, for instance polyethylene imines, polymers containing vinyl pyridine or vinylpyridinium units, condensates of polyamines, epichlorhydrine, quaternary polyureylenes and chitin derivatives.

In at least one embodiment of the present disclosure, the cationic polymers that may be used are cationic polymers belonging to family (10), for example hexadimethrine chloride (INCI name), marketed by CHIMEX under the reference MEXOMERE PO.

The cationic polymer is present in the composition of the present disclosure in an amount ranging from 0.01 to 10% by weight relative to the total weight of the composition, for example from 0.05 to 5% and further for example from 0.1 to 3%.

According to at least one embodiment, the at least one cosmetic active agent that may be used in the composition may be chosen from silicones.

The silicones that may be present in the reducing composition of the present disclosure are polyorganosiloxanes, for example oils, waxes, resins or gums which are not soluble in said composition.

Organopolysiloxanes are defined, for instance in Walter NOLL's “Chemistry and Technology of Silicones” (1968) Academie Press. They may be volatile or non-volatile.

Examples of volatile silicones include, but are not limited to those having a boiling point ranging from 60° C. to 260° C., such as:

(i) cyclic silicones comprising from 3 to 7 silicon atoms, for example 4 or 5.

Suitable examples thereof may include, but are not limited to octamethylcyclotetrasiloxane marketed, for instance under the trade name “VOLATILE SILICONE 7207” by UNION CARBIDE or “SILBIONE 70045 V 2” by RHONE POULENC, decamethylcyclopentasiloxane marketed, for example under the trade name “VOLATILE SILICONE 7158” by UNION CARBIDE, “SILBIONE 70045 V 5” by RHONE POULENC, and mixtures thereof.

Cyclocopolymers of the dimethyl siloxane and methylalkyl siloxane type that may be mentioned include, but are not limited to the product marketed, for example under the trade name “SILICONE VOLATILE FZ 3109” by UNION CARBIDE, having the following chemical structure (X):

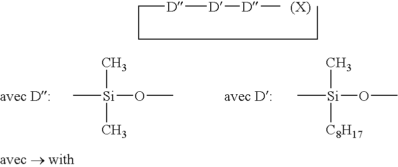

Mixtures of cyclic silicones with organic compounds derived from silicon that may be mentioned, include but are not limited to the octamethyl cyclotetrasiloxane and tetratrimethylsilyl pentaerythritol mixture (50:50) and the octamethyl cyclotetrasiloxane and oxy-1,1′(hexa-2,2,2′,2′,3,3′-trimethylsilyloxy)bis-neopentane mixture;

(ii) linear volatile silicones having from 2 to 9 silicon atoms wherein the viscosity is less than or equal to 5.10⁻⁶ m²/s at 25° C., for example decamethyl tetrasiloxane marketed under the trade name “SH 200” by TORAY SILICONE. Silicones belonging to this class are also described, for instance in the article published in Cosmetics and toiletries, Vol. 91, Jan. 76, P. 27-32—TODD & BYERS “Volatile Silicone fluids for cosmetics”.

In at least one embodiment, non volatile silicones are used, and may be chosen from, for example, polyalkyl siloxanes, polyaryl siloxanes, polyalkylaryl siloxanes, gums and silicone resins, polyorganosiloxanes modified with organofunctional groups as well as mixtures thereof.

According to the present disclosure, other useful silicones may include, but are not limited to polyalkyl siloxanes, for example polydimethyl siloxanes with trimethylsilyl end groups wherein the viscosity may range from 5.10⁻⁶ to 2.5 m²/s at 25° C., for example from 1.10⁻⁵ to 1 m²/s. Silicone viscosity is, for example measured at 25° C. according to ASTM 445 standard, Appendix C.

These polyalkyl siloxanes include, but are not limited to, the following commercial products:
SILBIONE fluids of 47 and 70 047 series or MIRASIL fluids, for instance by RHONE POULENC, such as for example fluid 70 047 V 500 000;
fluids of MIRASIL series marketed by RHONE POULENC;
fluids of 200 series from DOW CORNING, for example DC200 (viscosity 60 000 Cst);
VISCASIL fluids from GENERAL ELECTRIC and some fluids of SF (SF 96, SF 18) series from GENERAL ELECTRIC.

Dimethylsilanol end group-containing polydimethyl siloxanes may also be mentioned (referred to as dimethiconol in the CTFA dictionary), such as fluids of 48 series from RHONE POULENC.

Other useful polyalkyl siloxanes may include products marketed, for example under the trade names “ABIL WAX 9800 and 9801” by GOLDSCHMIDT which are (C₁-C₂₀) polyalkyl siloxanes.

In at least one embodiment of the present disclosure, polyalkylaryl siloxanes may be chosen from linear and/or branched, polydimethyl methylphenyl siloxanes, or polydimethyl diphenyl siloxanes with a viscosity ranging from 1.10⁻⁵ to 5.10⁻² m²/s at 25° C.

Suitable examples of such polyalkylaryl siloxanes include, but are not limited to products marketed under the following trade names:
SILBIONE fluids of 70 641 series from RHONE POULENC;
fluids of RHODORSIL 70 633 and 763 series from RHONE POULENC;
DOW CORNING 556 COSMETIC GRAD FLUID from DOW CORNING;
silicones of PK series from BAYER, such as the PK20 product;
silicones of PN, PH series from BAYER, such as PN1000 and PH1000 products; and
some fluids of SF series from GENERAL ELECTRIC, such as SF 1023, SF 1154, SF 1250, SF 1265.

According to the present disclosure, silicone gums that may be present in the reducing composition may be polydiorganosiloxanes having a high number average molecular weight ranging from 200 000 to 1 000 000, used either alone or in combination in a solvent. Useful solvents may include, but are not limited to volatile silicones, polydimethyl siloxanes fluids (PDMS), polyphenylmethyl siloxane fluids (PPMS), isbparaffins, polyisobutylenes, methylene chloride, pentane, dodecane, tridecanes and mixtures thereof.

Non-limiting mention may be made of the following products:

polydimethyl siloxane;

polydimethyl siloxane/methylvinyl siloxane gums;

polydimethyl siloxane/diphenyl siloxane;

polydimethyl siloxane/phenylmethyl siloxane; and

polydimethyl siloxane/diphenyl siloxane/methylvinyl siloxane.

According to at least one embodiment of the present disclosure, products that may be used herein include, but are not limited to the following:

mixtures formed from end chain-hydroxylated polydimethyl siloxane (referred to as dimethiconol in the CTFA dictionary) and cyclic polydimethyl siloxane (referred to as cyclomethicone in the CTFA dictionary), such as the Q2 1401 product marketed by DOW CORNING;

mixtures formed from polydimethyl siloxane gum and cyclic silicone, such as the SF 1214 Silicone Fluid from GENERAL ELECTRIC product, which is a SF 30 gum corresponding to a dimethicone, having a number average molecular weight of 500 000 soluble in the SF 1202 Silicone Fluid corresponding to decamethyl cyclopentasiloxane;

mixtures from two PDMS with different viscosities, for example from a PDMS gum and a PDMS fluid, such as the SF 1236 product from GENERAL ELECTRIC. SF 1236 is a mixture of a SE 30 gum as defined above with a viscosity of 20 m²/s and a SF 96 fluid with a viscosity of 5.10⁻⁶ m²/s, Wherein the product may comprise, for example 15% of SE 30 gum and 85% of SF 96 fluid.

Organopolysiloxane resins optionally present in the oxidizing composition of the method disclosed herein are siloxane-based crosslinked systems comprising the following units: R₂SiO_{1/2}, R₃SiO_{1/2}, RSiO_{3/2} and SiO_{4/2}, wherein R is a C₁-C₁₆ hydrocarbon group or a phenyl group. In at least one embodiment, R is a lower C₁-C₄ alkyl radical, for example a methyl or a phenyl radical.

Useful resins include but are not limited to the product marketed, for example under the trade name “DOW CORNING 593” or those marketed, for instance under the trade names “SILICONE FLUID SS 4230 and SS 4267” by GENERAL ELECTRIC and which are dimethyl/trimethyl siloxane-structured silicones.

Non-limiting mention may also be made of resins of the trimethyl siloxysilicate type marketed, for example under the trade names X22-4914, X21-5034 and X21-5037 by SHIN-ETSU.

Organomodified silicones optionally present in the reducing composition of the present disclosure are silicones, such as previously defined and comprising in their structure at least one organofunctional group bound by means of a hydrocarbon radical.

Examples of organomodified silicones include but are not limited to polyorganosiloxanes comprising:

polyethyleneoxy and/or polypropyleneoxy groups optionally comprising C₆-C₂₄ alkyl groups, such as products called dimethicone copolyol marketed by DOW CORNING under the trade name DC 1248 and SILWET L 722, L 7500, L 77, L 711 fluids from UNION CARBIDE and (C₁₂)alkyl methicone copolyol marketed by DOW CORNING under the trade name Q2 5200;

substituted or unsubstituted amine groups, such as the products marketed under the trade name GP 4 Silicone Fluid and GP 7100 by GENESEE, the 176-12096G products from GENERAL ELECTRIC, the KF-860, 861 and 864 products from SHINETSU and the products marketed under the trade names Q2 8220 or DCZ-8566 and DOW CORNING 929 or 939 or DCZ-8299 or QZ7224 by DOW CORNING. These substituted amine groups include, for example C₁-C₄ aminoalkyl groups; amino silicones comprising alkoxy groups, such as BELSIL ADM LOG 1 silicone marketed by WACKER;

thiol groups, such as the products marketed under the trade names “GP 72 A” and “GP 71” from GENESEE;

alkoxyl groups, such as the product marketed under the trade name “SILICONE COPOLYMER F-755” by SWS SILICONES and ABIL WAX 2428, 2434 and 2440 by GOLDSCHMIDT;

hydroxyl groups, such as polyorganosiloxanes comprising hydroxyalkyl functional groups, such as those described in French Patent Application No. 85 16334;

acyloxyalkyl groups, such as polyorganosiloxanes described in U.S. Pat. No. 4,957,732;

anionic groups of the carboxylic type, for example those in the products described in European Patent No. 0 186 507 from CHISSO CORPORATION, and of the alkyl carboxylic type, such as those present in the X-22-3701 E product from SHIN-ETSU; 2-hydroxyalkyl sulfonate; 2-hydroxyalkyl thiosulfate, such as products marketed by GOLDSCHMIDT under the trade names “ABIL S201” and “ABIL S255”;

hydroxyacylamino groups, such as polyorganosiloxanes described in European Patent Application No. 342 834, and the product Q2-8413 from DOW CORNING.

In at least one embodiment, the silicone is an amino silicone.

As described herein, the method of the invention comprises applying an oxidizing composition to keratin fibers.

The oxidizing composition comprises at least one oxidizing agent chosen from hydrogen peroxide, carbamide peroxide, alkaline bromates, polythionates, persalts, such as perborates, percarbonates and persulfates.

In at least one embodiment, the at least one oxidizing agent is hydrogen peroxide.

The at least one oxidizing agent is present in an amount ranging from 0.1 to 10%, for example from 0.5 to 5% by weight relative to the total weight of the oxidizing composition.

In at least one embodiment, when the oxidizing agent is hydrogen peroxide in an aqueous solution, the oxidizing composition used in the method according to the present disclosure comprises at least one hydrogen peroxide stabilizing agent. Such agents may be chosen from, for example, alkaline metal or alkaline-earth metal pyrophosphates, such as tetrasodium pyrophosphate, alkaline metal or alkaline-earth metal stannates, phenacetine or acid and oxyquinoline salts, such as oxyquinoline sulfate. In at least one embodiment, at least one stannate is used in combination with at least one pyrophosphate.

The at least one hydrogen peroxide stabilizing agent is present in an amount ranging from 0.0001% to 5% by weight, for example from 0.01 to 2% by weight relative to the total weight of the oxidizing composition.

To improve the cosmetic properties of the hair fibers or to reduce or prevent their damaging, the oxidizing composition used in the method as disclosed herein may also comprise at least one cosmetic active agent, such as those previously mentioned with respect to the reducing composition.

The pH value of the oxidizing composition, according to the present disclosure, may range from 1.5 to 4.5, for example from 2 to 3.5.

In at least one embodiment, the oxidizing composition is allowed to react for a period of time ranging from 2 to 30 minutes, for example from 2 to 15 minutes, and further for example from 2 to 7 minutes.

According to at least one embodiment, the method of the invention further comprises the application of a hair-care composition comprising a cationic polymer.

All the cationic polymers that have been described above for the reducing composition may also be used in the hair-care composition.

According to at least one embodiment, the reducing composition may comprise cyclopolymers, for example dimethyldiallylammonium chloride homopolymers marketed under the trade name “MERQUAT® 100” by MERCK, diquaternary ammonium polymers of formula (VIII) or of formula (IX) and MEXOMERE PO. In at least one embodiment, the silicone is WACKER BELSIL ADM LOG 1.

As noted above, the presently disclosed method may include applying a hair-care composition to keratin fibers during the permanent reshaping process. Doing so may limit or prevent the hair becoming damaged as a result of the reducing agents and the oxidizing agents typically used during the process for permanently reshaping the hair according to the present disclosure. The hair-care composition, such as defined herein may also protect the artificial hair color.

The oxidizing composition and the hair-care composition according to the present disclosure may also comprise at least one cosmetic active agent, such as those previously mentioned with respect to the reducing composition.

As disclosed herein, the vehicle for the reducing, oxidizing and hair-care compositions used in the presently disclosed method is, in at least one embodiment, an aqueous medium comprising water and optionally, in a further embodiment, at least one cosmetically acceptable organic solvent, such as alcohols, for example ethyl alcohol, isopropyl alcohol, benzyl alcohol and phenylethyl alcohol, and polyols or polyol ethers, such as, ethylene glycol monomethyl, monoethyl and monobutyl ethers, propylene glycol and ethers thereof, such as, propylene glycol monomethylether, butylene glycol, dipropylene glycol and diethylene glycol alkyl ethers, such as diethylene glycol monoethylether and monobutylether. The organic solvents that may be present in an amount ranging from about 0.1 to 20%, for example from about 1 to 10% by weight relative to the total weight of the composition.

The pH value of the reducing composition, the oxidizing composition and the hair-care composition as disclosed herein may be obtained and/or adjusted traditionally by adding alkaline agents, such as ammonia, monoethanol amine, diethanol amine, triethanol amine, isopropanol amine, 2-methyl-2-amino-1-propanol, propanediamine-1,3, alkaline, ammonium carbonate or bicarbonate, organic carbonate, such as guanidine carbonate, and alkaline hydroxide, and combinations thereof, or by adding acidifying agents, such as hydrochloric acid, acetic acid, lactic acid, boric acid, citric acid and phosphoric acid.

As disclosed herein, the reducing composition, the oxidizing composition and the hair-care composition used in the present method may be present independently of each other in the form of a lotion, a thickened gel, a non-thickened gel, a foam, or a cream. According to at least one embodiment of the present disclosure, the method may further comprise applying a composition comprising a fixing polymer, for instance applying it after setting the keratin fibers under mechanical tension and before applying the reducing composition.

To use the immediately above-defined composition, it is theoretically possible to use any natural or synthetic fixing polymer giving a form to the hair or changing said hair form. In at least one embodiment, the fixing polymer used is anionic or amphoteric in nature, and mixtures of anionic and amphoteric polymers may also be used. Examples of anionic polymers include, but are not limited to polymers comprising groups derived from carboxylic, sulfonic and phosphoric acids, and having a weight average molecular weight ranging from 500 to 5 000 000.

Carboxylic groups are derived from unsaturated carboxylic monoacid or diacid monomers, such as those of following formula (XI):

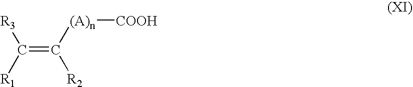

wherein n is an integer from 0 to 10; A is a methylene group, optionally bound to the carbon atom of the unsaturated group or to the adjacent methylene group when n is higher than 1, by means of a heteroatom, such as oxygen or sulfur; R1 is chosen from a hydrogen atom, a phenyl group and a benzyl group; R2 is chosen from a hydrogen atom, a lower alkyl group and a carboxyl group; R3 is chosen from a hydrogen atom, a lower alkyl group, a —CH2—COOH, a phenyl group and a benzyl group.

In at least one embodiment, the formula (XI) defined above may comprise a lower alkyl group comprising from 1 to 4 carbon atoms, for example methyl and ethyl groups.

Examples of carboxylic or sulfonic group-containing anionic polymers include but are not limited to:

A) homo- or copolymers of acrylic or methacrylic acid and their salts, including copolymers of acrylic acid and acrylamide and copolymers of methacrylic acid, acrylic acid, ethyl acrylate/methyl methacrylate, for example AMERHOLD DR 25 marketed by AMERCHOL, and polyhydroxycarboxylic acid sodium salts. Non-limiting mention may also be made of copolymers of methacrylic acid and ethyl acrylate, for example, in aqueous dispersion, such as LUVIFLEX SOFT and LUVIMER MAE marketed by BASF.

B) copolymers of acrylic or methacrylic acids with a monoethylene monomer, such as ethylene, styrene, vinyl esters, acrylic and methacrylic acid esters, which are optionally graft onto polyalkylene glycol, such as polyethylene glycol, that may optionally be crosslinked. Such polymers are described, for example in French Patent No. 1 222 944 and in German Patent Application No. 2 330 956. Copolymers of this type may comprise in their chain an optionally N-alkylated and/or hydroxyalkylated acrylamide unit, such as those described, for instance in Luxemburger Patent Application Nos. 75370 and 75371. Non-limiting mention may also be made of copolymers of acrylic acid and C₁-C₄ alkyl methacrylate.

C) copolymers derived from crotonic acid, such as those comprising in their chain vinyl acetate or propionate units, and optionally other monomers, such as allyl or methallyl ester, vinyl ether or vinyl ester of a saturated, linear or branched, hydrocarbon long-chain carboxylic acid, such as those comprising at least 5 carbon atoms, wherein these polymers may optionally be graft and crosslinked, or a vinyl, allyl or methallyl ester of a cyclic α- or β-carboxylic acid. Such polymers are described inter alia in French Patent Nos. 1 222 944, 1 580 545, 2 265 782, 2 265 781, 1 564 110 and 2 439 798. Examples of commercial products belonging to this class are, for example the 28-29-30, 26-13-14 and 28-13-10 resins sold by NATIONAL STARCH.

Non-limiting mention may be made of copolymers derived from crotonic acid, terpolymers of crotonic acid/vinyl acetate/vinyl tertbutylbenzoate, for instance MEXOMERE PW marketed by CHIMEX.

D) polymers derived from maleic, fumaric, itaconic acids or anhydrides with vinyl esters, vinyl ethers, vinyl halides, phenylvinyl derivatives, acrylic acid and esters thereof; these polymers may be esterified. Such polymers are described, for example in U.S. Pat. Nos. 2,047,398, 2,723,248, and 2,102,113, and British Patent No. 839 805, and those sold under the trade names GANTREZ® AN or ES by ISP.

Useful polymers that may be mentioned include, but are not limited to copolymers of maleic, citraconic, itaconic anhydrides with an allyl or methallyl ester optionally comprising an acrylamide or methacrylamide group, an α-olefin, acrylic or methacrylic ester, acrylic or methacrylic acids or vinyl pyrrolidone in their chain, the anhydride functions being monoesterified or monoamidified. These polymers are described, for example in French Patent Nos. 2 350 384 and 2 357 241.

E) polyacrylamides comprising carboxylate groups.

F) polymers comprising sulfonic groups. Such polymers may comprise vinyl sulfonic, styrene sulfonic, naphthalene sulfonic, acrylamido alkyl sulfonic, and sulfoisophthalate units.

These polymers may, for example, chosen from:

polyvinyl sulfonic acid salts having a molecular weight ranging from about 1 000 to 100 000, and copolymers with an unsaturated comonomer, such as acrylic and methacrylic acids, and esters thereof, and acrylamide and derivatives thereof, vinyl ethers and vinyl pyrrolidone;

polystyrene sulfonic acid salts, sodium salts, having a molecular weight ranging from about 500 000 to about 100 000. These compounds are described, for instance in French Patent No. 2 198 719;

polyacrylamide sulfonic acid salts, such as those mentioned in U.S. Pat. No. 4,128,631;

G) silicone anionic graft polymers;

Silicone graft polymers that may be used are chosen from polymers with an organic non silicone backbone, graft with polysiloxane-containing monomers, polysiloxane backbone polymers graft with non silicone organic monomers and mixtures thereof.

As used herein, a silicone or a polysiloxane is understood to mean any organosiliced oligomer polymer with a linear or cyclic, branched or crosslinked structure, having a varying molecular weight, obtained by polymerizing and/or polycondensing suitably functionalized silanes, and substantiallycomprising repeating main units, wherein the silicon atoms are bound to each other with oxygen atoms (siloxane bond ≡—Si—O—Si≡), optionally substituted with hydrocarbon radicals that are directly bound by means of a carbon atom on said silicon atoms, for example alkyl radicals and further for example C₁-C₁₀ alkyl radicals such as methyl radicals, fluoralkyl radicals, aryl radicals, phenyl radicals, alkenyl radicals and vinyl radicals; other types of radicals that might be bound either directly, or by means of a hydrocarbon radical, to the siloxane chain are for example hydrogen, halogens, for instance chlorine, bromine and fluorine, thiols, alkoxy radicals, polyoxyalkylene radicals (or polyethers), polyoxyethylene and/or polyoxypropylene hydroxyl and hydroxyalkyl radicals, substituted or non-substituted amine groups, amide groups, acyloxy and acyloxyalkyl radicals, hydroxyalkylamino and aminoalkyl radicals, quaternary ammonium groups, amphoteric or betaine groups, anionic groups, such as carboxylates, thioglycolates, sulfosuccinates, thiosulfates, phosphates and sulfates, this list being of course absolutely not limitative (and including silicones that are said to be “organomodified”).

As used herein, “polysiloxane macromer” in understood to mean any monomer comprising a polysiloxane type polymer chain.

As disclosed herein, polymers with an organic non silicone backbone, graft with polysiloxane-containing monomers, comprise an organic main chain formed from organic monomers that do not comprise silicone, onto which at least one polysiloxane macromer has been graft within the said chain, as well as optionally to at least one end thereof.

In at least one embodiment, the non silicone organic monomers forming the main chain of the silicone graft polymer may be chosen from ethylenically unsaturated free-radical polymerizable monomers, polycondensation polymerizable monomers, such as those forming polyamides, polyesters, polyurethanes, and open-ring monomers, such as those of the oxazoline and caprolactone type.

Polymers with an organic non silicone backbone, graft with polysiloxane-containing monomers to be used may be obtained according to any means known in the art, for example by reacting (i) an initial polysiloxane macromer suitably functionalized on the polysiloxane chain with (ii) at least one non silicone organic compound, that are in turn suitably functionalized with a function that can react with the functional group(s) carried on said silicone by forming a covalent bond; an example of such a reaction being the radical reaction between a vinyl group carried on one of the silicone ends with a double bond of an ethylenically unsaturated monomer of the main chain.

The polymers with an organic non silicone backbone, graft with polysiloxane-containing monomers, according to the present disclosure, may be chosen from those described in U.S. Pat. Nos. 4,693,935, 4,728,571 and 4,972,037 and in European Patent Application Nos. 0 412 704, 0 412 707, 0 640 105 and International Application No. WO 95/00578. Such copolymers are obtained by means of a radical polymerization from ethylenically unsaturated monomers and silicone macromers having a vinyl end group or copolymers obtained by reacting a polyolefin comprising functionalized groups with a polysiloxane macromer having an end function reactive with said functionalized groups.

In at least one embodiment, the silicone graft polymer family that may be suitably used comprises silicone graft copolymers comprising:

a) from 0 to 98% by weight of at least one lipophilic, ethylenically unsaturated, free-radical polymerizable (A′) monomer having a low polarity;

b) from to 98% by weight of at least one hydrophilic, polar, ethylenically unsaturated monomer (B′) copolymerizable with the monomer(s) of type (A);

c) from 0.01 to 50% by weight of at least one polysiloxane macromer (C′) of general formula (XII):

X(Y)nSi(R)₃-mZm (XII)

wherein:

X is a vinyl group copolymerizable with monomers (A′) and (B′);

Y is a divalent linkage group;

R is chosen from a hydrogen atom, a C₁-C₆ alkyl or -alkoxy group, and a C₆-C₁₂ aryl group;

Z is a monovalent polysiloxane unit having a number average molecular weight of at least 500;

n is 0 or 1 and m is an integer ranging from 1 to 3; wherein the percentages are calculated relative to the total weight of (A′), (B′) and (C′).

The polymers, and their preparation methods are described in U.S. Pat. Nos. 4,963,935, 4,728,571 and 4,972,037 and in European Patent Applications 0 412 704, 0 412 707, and 0 640 105. They have a number average molecular weight ranging from 10 000 to 2 000 000 and a glass transition temperature Tg or a crystalline melting point Tm of at least −20° C.

Suitable examples of lipophilic monomers (A′) include C₁-C₁₈ alcohol acrylic or methacrylic acid esters, styrene, polystyrene macromers, vinyl acetate, vinyl propionate, alpha-methylstyrene, tertio-butylstyrene, butadiene, cyclohexadiene, ethylene, propylene, vinyltoluene, esters of acrylic and methacrylic acid and of 1,1-dihydroperfluoroalkanol and homologues thereof, esters of acrylic and methacrylic acid and omega-hydrydofluoroalkanol, esters of acrylic and methacrylic acid and fluoroalkylsulfoamido alcohol, esters of acrylic and methacrylic acid and fluoroalkyl alcohol, esters of acrylic and methacrylic acid and alcohol fluoroether, and mixtures thereof.

Suitable examples of monomers (A′) include, but are not limited to n-butyl methacrylate, isobutyl methacrylate, tertio-butyl acrylate, tertio-butyl methacrylate, 2-ethylhexyl methacrylate, methyl methacrylate, 2-(N-methyl perfluoroctane sulfoamido)ethylacrylate; 2-(N-butylperfluorooctane sulfoamido)ethylacrylate and mixtures thereof.

Suitable examples of polar monomers (B′) include but are not limited to acrylic acid, methacrylic acid, N,N-dimethylacryl amide, dimethylaminoethyl methacrylate, quaternized dimethylaminoethyl methacrylate, (meth)acrylamide, N-t-butyl acrylamide, maleic acid, maleic anhydride and their half-esters, hydroxyalkylated (meth)acrylates, diallyidimethylammonium chloride, vinyl pyrrolidone, vinyl ethers, maleimides, vinyl pyridine, vinyl imidazole, heterocyclic vinyl polar compounds, styrene sulfonate, allyl alcohol, vinyl alcohol, vinyl caprolactame and mixtures thereof. In at least one embodiment, monomers (B′) are chosen from acrylic acid, N,N-dimethylacryl amide, dimethylaminoethyl methacrylate, quaternized dimethylaminoethyl methacrylate, vinyl pyrrolidone and mixtures thereof.

The anionic silicone graft polymers that comprise polar monomers (B′) as used herein, comprise at least one anionic monomer.

In at least one embodiment, polysiloxane macromers (C′) of formula (XII) are chosen from those of the following formula (XIII):

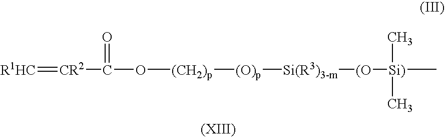

wherein:

R1 is chosen from hydrogen and —COOH, for example hydrogen;

R2 is chosen from hydrogen, a methyl group and —CH₂COOH, for example a methyl group;

R3 is chosen from a C₁-C₆ alkyl, alkoxy or alkylamino group, a C₁-C₁₂ aryl group and a hydroxyl group, for example a methyl group;

R4 is chosen from a C₁-C₆ alkyl, alkoxy or alkylamino group, a C₁-C₁₂ aryl group and a hydroxyl group, for example a methyl group;

q is an integer ranging from 2 to 6, for example 3;

p is 0 or 1;

r is an integer ranging from 5 to 700;

m is an integer ranging from 1 to 3, for example 1;

In at least one embodiment, polysiloxane macromers of the following formula are used:

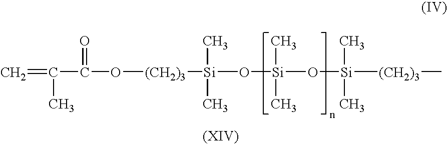

wherein n is an integer ranging from 5 to 700.

According to at least one embodiment of the present disclosure, the copolymer may be obtained by free-radical polymerization from a mixture of monomers comprising:

60% by weight of tertiobutyl acrylate:

20% by weight of acrylic acid; and

20% by weight of silicone macromer of formula:

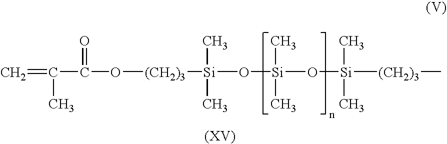

wherein n is an integer ranging from 5 to 700; wherein the percentages by weight are calculated relative to the total weight of the monomer.

According to another embodiment of the present disclosure, a silicone polymer family includes silicone graft copolymers that may be obtained by reactive extrusion of a polysiloxane macromer having a reactive end function on a polyolefin-type polymer comprising reactive groups that may react with the end function of the polysiloxane macromer to form a covalent bond enabling grafting of the silicone on the polyolefin main chain.

These polymers, as well as their preparation methods, are described, for example in International Patent Application No. WO 95/00578.

Examples of reactive polyolefins include, but are not limited to polyethylenes or polymers of monomers derived from ethylene, such as propylene, styrene, alkyl styrenes, butylene, butadiene, (meth)acrylates, vinyl esters or equivalents, comprising reactive functions that may react with the end function of the polysiloxane macromer. They may b chosen from copolymers of ethylene and ethylene derivatives and of monomers chosen from those comprising a carboxylic function, such as (meth)acrylic acid; those comprising an acid anhydride function, such as maleic acid anhydride; those comprising an acid chloride function, such as (meth)acrylic acid chloride; those comprising an ester function, such as (meth)acrylic acid esters; and those comprising an isocyanate function. Examples of silicone macromers include, but are not limited to polysiloxanes comprising a functionalized group, at the end of the polysiloxane chain or close to the end of said chain, chosen from alcohols, thiols, epoxy, primary and secondary amines and, in a further embodiment, those of following formula (XVI):

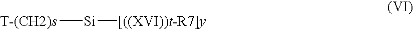

wherein T is chosen from NH2, NHR′, an epoxy function, OH, and SH; R5, R6, R7 and R′, independently, are chosen from C₁-C₆ alkyl groups, phenyl groups, benzyl groups, C₆-C₁₂ alkyl phenyl groups, and hydrogen; s is a number ranging from 2 to 100; t is a number ranging from 0 to 1000 and y is a number ranging from 1 to 3. Such macromers have a number average molecular weight ranging from 5 000 to 300 000, for example from 8 000 to 200 000 and further for example from 9 000 to 40 000.

According to the present disclosure, the graft silicone polymer(s) having a polysiloxane backbone graft with non silicone organic monomers comprise a silicone main chain (or polysiloxane (≡Si—O—)n), wherein at least one organic group free from silicone is graft within said chain as well as optionally to at least one end thereof.

Polysiloxane backbone polymers graft with non silicone organic monomers, as disclosed herein may be existing commercial products or may be obtained by methods known in the art, for example by making (i) a starting silicone suitably functionalized on at least one of its silicon atoms react with (ii) a non-silicone organic compound suitably functionalized with a function that can react with the functional group(s) carried on said silicone by forming a covalent bond; for example is the hydrosylilation reaction between ≡Si—H groups and CH2=CH— vinyl groups, or the reaction between —SH thio-functional groups with said vinyl groups.

Examples of polysiloxane backbone polymers graft with non silicone organic monomers as well as their preparation procedure, are described, for instance in European Patent Application No. 0 582 152, and International Patent Application Nos. WO 93/23009 and WO 95/03776, the teachings of which are incorporated herein by reference.

According to at least one embodiment of the present disclosure, the polysiloxane backbone silicone polymer, graft with non silicone organic monomers, comprises the result of a radical copolymerization between, on the one hand, at least one ethylenically unsaturated, organic anionic non-silicone monomer and/or at least one ethylenically unsaturated organic hydrophobic non-silicone monomer and on the other hand, a silicone that does contain in its chain at least one functional group that can be reacted with said ethylenic unsaturations of said non-silicone monomers by forming a covalent bond, for example thio-functional groups.

According to the present disclosure, said anionic ethylenically unsaturated monomers are, in at least one embodiment, chosen from, either alone or in combinations, linear or branched, unsaturated carboxylic acids, that have been optionally partially or totally neutralized in the form of a It, where the unsaturated carboxylic acid(s) may be, for example acrylic acid, methacrylic acid, maleic acid, maleic anhydride, itaconic acid, fumaric acid and crotonic acid. Suitable salts are, for instance alkaline metal, alkaline-earth metal and ammonium salts. In at least one embodiment, in the final silicone graft polymer, the anionic type organic group, which comprises the radical (homo)polymerization result of at least one anionic monomer of the unsaturated carboxylic acid type may be, after reaction, post-neutralized with a base (soda, ammonia, and so on) to convert it into a salt.

According to the present disclosure, hydrophobic ethylenically unsaturated monomers are chosen, in at least one embodiment, either alone or in combination, from alkanol acrylic acid esters and/or alkanol methacrylic acid esters. Alkanols are, for example C₁-C₁₈ alkanols such as C₁-C₁₂ alkanols. In at least one embodiment, monomers are chosen from isooctyl (meth)acrylate, isononyl (meth)acrylate, 2-ethylhexyl (meth)acrylate, lauryl (meth)acrylate, isopentyl (meth)acrylate, n-butyl (meth)acrylate, isobutyl (meth)acrylate, methyl (meth)acrylate, tertio-butyl (meth)acrylate, tridecyl (meth)acrylate, stearyl (meth)acrylate and mixtures thereof.

According to at least one embodiment, a family of silicone polymers with a polysiloxane backbone graft with non silicone organic monomers suitable for the present disclosure comprises silicone polymers comprising in their structure a unit of following formula (XVII):

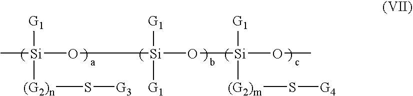

wherein G1 radicals, which may be identical or different, are chosen from hydrogen, C₁-C₁₀ alkyl radicals and phenyl radicals; G2 radicals, which may be identical or different, are C₁-C₁₀ alkyl groups; G3 is a polymer residue resulting from the (homo)polymerization of at least one ethylenically unsaturated anionic monomer; G4 is a polymer residue resulting from the (homo)polymerization of at least one ethylenically unsaturated hydrophobic monomer; m and n are 0 or 1; a is an integer ranging from 0 to 50; b is an integer ranging from 10 to 350, c is an integer ranging from 0 to 50; with the proviso that one of these parameters a and c is different from 0.

In at least one embodiment, the unit of the above formula (XVII) has at least one of, and, in a further embodiment, all of, the following characteristics:

G1 radicals are chosen from alkyl radicals, such as methyl radicals;

n is different from zero, and the G2 radicals are C₁-C₃ divalent radicals, for example propylene radicals;

G3 is a polymer radical resulting from the (homo)polymerization of at least one monomer of the ethylenically unsaturated carboxylic acid type, for example acrylic acid and/or methacrylic acid;

G4 is a polymer radical resulting from the (homo)polymerization of at least one monomer of the (C₁-C₁₀) alkyl (meth)acrylate type, for instance isobutyl or methyl (meth)acrylate.

Non-limiting examples of silicone graft polymers of the following formula (XVII) are polydimethyl siloxanes (PDMS) on which mixed polymer units of the poly(meth)acrylic acid type and methyl poly(meth)acrylate type have been graft, by a thiopropylene-type link.

In at least one embodiment of the present disclosure, the number average molecular weight of the silicone polymers with a polysiloxane backbone graft with non silicone organicmonomers varies from about 10 000 to 1 000 000, for instance from about 10 000 to 100 000.

Suitable silicone graft polymers according to the present disclosure include the product marketed by 3M under the reference VS80.

H)-anionic polyurethanes.

In another embodiment, polyurethanes that may be used according to the present disclosure have a base repeating unit of following formula (XVIII):

—X′—B″X′—CO—NH—R—NH—CO— (XVIII)

wherein

X′ is O and/or NH;

B″ is a divalent substituted or unsubstituted hydrocarbon radical; and

R is a divalent radical chosen from linear or branched alkylene radicals, of the C₆-C₂₀ aromatic type, C₁ to C₂₀ aliphatic type, for example C₁-C₆, C₁ to C₂ cycloaliphatic type, such as C₁-C₆, such radicals being optionally substituted by at least one halogen, C₁-C₄ alkoxy, and C₆-C₃₀ aryl, for example, phenyl, group(s).

In at least one embodiment, the B″ radical is a C₁-C₃₀ divalent radical, for example C₂-C₁₀ and carries a group having at least one carboxylic function and/or at least one sulfonic function, wherein the carboxylic and/or sulfonic functions are in a free form or partially or totally neutralized by a mineral or an organic base, such as alkaline metal or alkaline-earth metal hydroxides, ammonia and alkyl amines or alkanol amines, and organic amino acids. In another embodiment, the B″ radical is the divalent radical derived from dimethylol propionic acid.

According to at least one embodiment, the R radical is chosen from the radicals of the following formulae:

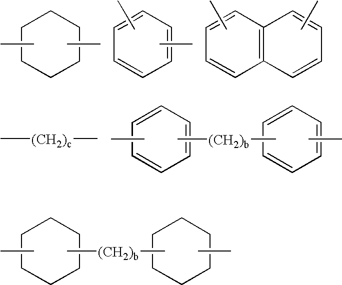

wherein b is an integer ranging from 0 to 3, and c an integer ranging from 1 to 20, for instance ranging from 2 to 12.

In another embodiment, the R radical is chosen from hexamethylene, 4,4′-biphenylene methane, 2,4- and/or 2,6-tolylene, 1,5-naphtylene, p-phenylene, methylene-4,4-bis-cyclohexyl radicals and isophorone divalent radical derivative.

According to at least one embodiment, the fixing polyurethanes may comprise silicone grafts and hydrocarbon silicone grafts.

In another embodiment, the polyurethane may comprise at least one polysiloxane sequence wherein its base repeating unit has, for example the following formula (XIX):

—X′—P—X′—CO—NH—R—NH—CO— (XIX)

wherein:

P is a polysiloxane segment;

X′ is chosen from O and/or NH; and

R is a divalent radical chosen from linear or branched, alkylene radicals of the C₆-C₂₀ aromatic type, C₁-C₂₀ aliphatic type, for instance C₁-C₆; and C₁-C₂₀ cycloaliphatic type, such as C₁-C₆, these radicals optionally substituted by at least one halogen, C₁-C₄ alkoxy, and C₁-C₃₀ aryl, for example phenyl group.

The R radical is advantageously chosen from radicals of following formulas:

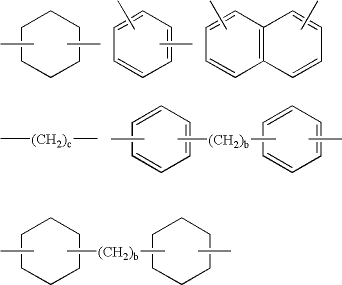

wherein b is an integer ranging from 0 to 3, and c an integer ranging from 1 to 20, for example ranging from 2 to 12.

In at least one embodiment, the R radical is chosen from hexamethylene, 4,4′-biphenylene methane, 2,4- and/or 2,6-tolylene, 1,5-naphtylene, p-phenylene, methylene-4,4-bis-cyclohexyl radicals and isophorone derived divalent radical.

In another embodiment, the P polysiloxane segment has the following formula (XX):

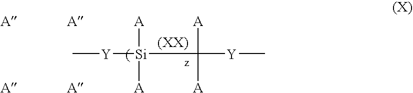

wherein:

A″ groups, which may be identical or different, are chosen from monovalent C₁ to C₂₀ hydrocarbon groups, substantially free from any ethylenic unsaturation and from aromatic groups;

Y is a divalent hydrocarbon group; and

Z is an integer, chosen so that the average molecular weight of the polysiloxane segment ranges from 300 to 10 000.

According to at least one embodiment, the Y divalent group is chosen from alkylene groups of formula —(CH2)a—, wherein a is an integer that may range from 1 to 10.

A″ groups may be chosen from C₁-C₁₈ alkyl groups, for example methyl, ethyl, propyl, isopropyl, butyl, pentyl, hexyl, octyl, decyl, dodecyl and octadecyl groups; cycloalkyl groups, such as cyclohexyl groups; aryl groups, for instance phenyl and naphthyl; arylalkyl groups, for example benzyl, phenylethyl, tolyl and xylyl groups.

Suitable examples of fixing polyurethanes according to the present disclosure include, but are not limited to copolymers of dimethylol propionic acid/isophorone diisocyanate/neopentyl glycol/polyester diols (also known under the trade name polyurethane-1, INCI name) marketed under the trade name Luviset® PUR by BASF, copolymers of dimethylol propionic acid, isophorone diisocyanate, neopentyl glycol, polyester diols, and silicone diamine (also known under the trade name polyurethane-6, INCI name) marketed under the trade name Luviset® if PUR A by BASF.

In at least one embodiment, AVALURE UR 450 is a suitable anionic polyurethane that may be used by way of non-limiting example.

In another embodiment, sulfoisophthalate group comprising polymers may be used, such as AQ55 and AQ48 polymers marketed by EASTMAN.

Non-limiting examples of anionic polymers include acrylic acid copolymers, such as terpolymer of acrylic acid/ethyl acrylate/N-tertiobutyl acrylamide marketed under the name ULTRAHOLD STRONG® by BASF; copolymers of methacrylic acid and ethyl acrylate in aqueous dispersion, such as LUVIFLEX SOFT and LUVIMER MAE marketed by BASF; copolymers derived from crotonic acid, such as terpolymers of vinyl acetate/vinyl tertio-butyl benzoate/crotonic acid and terpolymers of crotonic acid/vinyl acetate/vinyl neododecanoate marketed under the name Resin 28-29-30 by NATIONAL STARCH; polymers derived from maleic, fumaric, itaconic acids and anhydrides with vinyl esters, vinyl ethers, vinyl halides, phenylvinyl derivatives, acrylic acid and esters thereof, such as a copolymer of methyl vinylether and monoesterified maleic anhydride marketed under the name GANTREZ® ES 425 by ISP, LUVISET Si PUR, MEXOMERE PW; elastomer or non elastomer anionic polyurethanes; sulfoisophthalate group-containing polymers, anionic graft silicone polymers, as well as AMERHOLD DR 25 and VS 80.

Amphoteric polymers as disclosed herein include, but are not limited to polymers comprising B′″ and C′″ units statistically distributed within the polymer chain, wherein B′″ is a unit derived from a monomer comprising at least one basic nitrogen atom and C′″ is a unit derived from an acid monomer comprising at least one carboxylic or sulfonic groups, or B′″ and C′″ are groups derived from carboxybetaine or sulfobetaine zwitterionic monomers; B′″ and C′″ may also be chosen from cationic polymer chains comprising primary, secondary, tertiary or quaternary amine groups, wherein at least one amine group carries a carboxylic or sulfonic group bound by a hydrocarbon group, or B′″ and C′″ are part of a chain of an ethylene dicarboxylic unit-comprising polymer, one carboxylic group of which was reacted with a polyamine comprising at least one primary or secondary amine group.

In at least one embodiment, amphoteric polymers, as defined above, are chosen from the following polymers:

(1) polymers resulting from the copolymerization of a monomer derived from a vinyl compound bearing a carboxylic group, for example acrylic acid, methacrylic acid, maleic acid, alphachloracrylic acid, and from a basic monomer derived from a substituted vinyl compound comprising at least one basic atom, such as dialkylaminoalkyl methacrylate and acrylate, dialkylaminoalkyl methacrylamide and acrylamide. Such compounds are described in U.S. Pat. No. 3,836,537.

The vinyl compound may also be a dialkyldiallyl ammonium salt, such as diethyl diallylammonium chloride.

(2) polymers comprising units derived:

a) from at least one monomer chosen from acrylamides or methacrylamides substituted on the nitrogen atom with an alkyl group,

b) from at least one acidic comonomer comprising at least one reactive carboxylic group, and

from at least one basic monomer, such as esters with primary, secondary, tertiary and quaternary amine substituents of the acrylic and methacrylic acids, and the quaternization product of the dimethylaminoethyl methacrylate with dimethyl or diethyl sulfate.

N-substituted acrylamides or methacrylamides that are may be used in at least one embodiment according to the disclosure are groups with alkyl groups comprising from 2 to 12 carbon atoms, for instance N-ethyl acrylamide, N-tertiobutyl acrylamide, N-tertiooctyl acrylamide, N-octyl acrylamide, N-decyl acrylamide, N-dodecyl acrylamide and their corresponding methacrylamides.

Non-limiting examples of acidic comonomers include, but are not limited to acrylic, methacrylic, crotonic, itaconic, maleic and fumaric acids and alkyl monoesters having from 1 to 4 carbon atoms of the maleic or fumaric acids or anhydrides. In at least one embodiment, basic comonomers are aminoethyl, butylaminoethyl, N,N′-dimethylaminoethyl, and N-tertio-butylaminoethyl methacrylates are used. In another embodiment, copolymers which CTFA name (4th Ed, 1991) is octyl acrylamide/acrylate/butylaminoethyl methacrylate copolymer, such as products marketed under the name AMPHOMER® or LOVOCRYL® 47 by NATIONAL STARCH.

(3) crosslinked and partially or totally alkylated polyaminoamides derived from polyaminoamides of the following formula:

CO—R_{(XXI)} (XI)

wherein R4 is a divalent group derived from a saturated dicarboxylic acid, from an aliphatic, ethylene double bond-mono or dicarboxylic acid, from an ester of a lower alkanol having from 1 to 6 carbon atoms of these acids or from a group resulting from the addition of any of said acids with a bis-primary or bis-secondary derivative amine, and Z is a bis-primary, mono or bis-secondary polyalkylene polyamine and is present according to at least one embodiment:

a) in amounts ranging from 60 to 100% by mole, the group

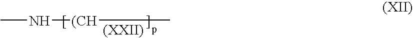

wherein x=2 and p=2 or 3, or x=3 and p=2

this group being derived from diethylene triamine, triethylene tetraamine or dipropylene triamine;

b) in amounts ranging from 0 to 40% by mole, the above (XXII) group, wherein x=2 and p=1 and which is derived from ethylene diamine, or the group derived from piperazine

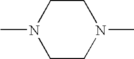

c) in amounts ranging from 0 to 20% by mole, the —NH—(CH2)₆—NH— group derived from hexamethylene diamine, wherein these polyaminoamines are crosslinked by adding a bifunctional crosslinking agent chosen from epihalohydrines, diepoxides, dianhydrides, and bis-unsaturated derivatives, using from 0.025 to 0.35 mole of crosslinking agent per amine group of the polyaminoamide, and alkylated by reaction with acrylic acid, chloracetic acid or an alkane-sultone or salts thereof.

In at least one embodiment, saturated carboxylic acids are chosen from acids comprising from 6 to 10 carbon atoms, such as adipic, 2,2,4-trimethyl adipic and 2,4,4-trimethyl adipic, terephthalic acids, and ethylene double bond-acids, for example, acrylic, methacrylic, and itaconic acids. Alkane-sultones used in the alkylation are for example propane- or butane-sultone, and the alkylating agent salts are for instance sodium or potassium salts.

(4) polymers comprising zwitterionic units of formula:

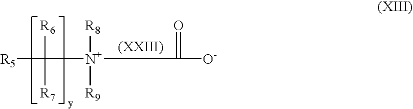

wherein R5 is an unsaturated polymerizable group, such as an acrylate, a methacrylate, acrylamide or methacrylamide group, y and z are integers ranging from 1 to 3, R6 and R7 are chosen from hydrogen atoms, methyl groups, ethyl groups and propyl groups, R8 and R9 are hydrogen atoms or alkyl groups, so that the sum of the carbon atoms in R10 and R11 does not exceed 10.

Polymers comprising such units may also comprise units derived from non zwitterionic monomers, such as dimethyl- or diethylaminoethyl acrylate or methacrylate, alkyl acrylates or methacrylates, acrylamides or methacrylamides, and vinyl acetate.

(5) polymers derived from chitosan comprising monomer units of the following formulae:

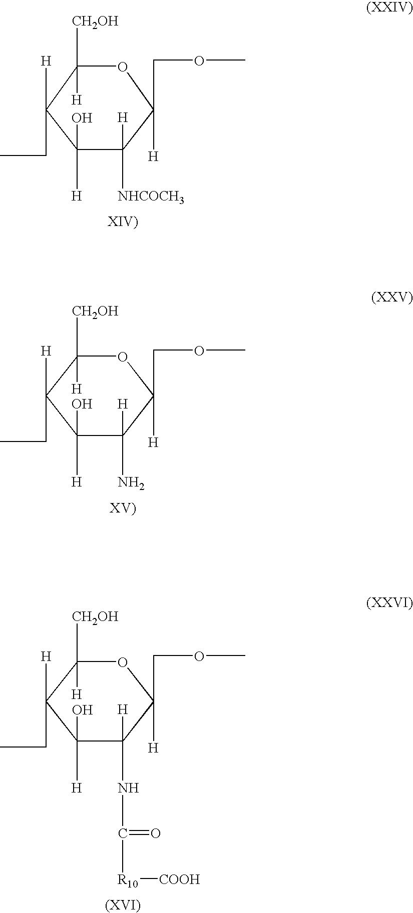

(XXIV) unit being present in amounts ranging from 0 to 30%, (XXV) unit in amounts ranging from 5 to 50% and (XXVI) unit in amounts ranging from 30 to 90%, wherein in this unit, R10 is a group of formula:

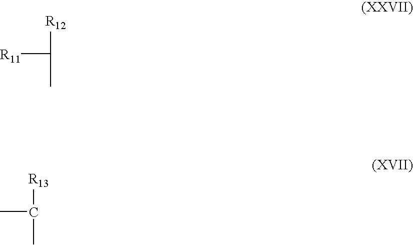

wherein if q=0, R11, R12 and R13, which may be identical or different, are chosen from hydrogen atoms, methyl residues, hydroxyl residues, acetoxy and amino residues, monoalkyl amine and dialkyl amine residues, optionally interrupted with least one nitrogen atom and/or optionally substituted by at least one amine, hydroxyl, carboxyl, alkylthio, sulfonic group, alkylthio residues wherein the alkyl group carries an amino residue, where at least one of the R17, R18 and R19 groups are in that case a hydrogen atom;

or if q=1, R1, R12 and R13 are hydrogen atoms, as well as salts formed by these compounds with bases or acids.

(6) Polymers derived from chitosan N-carboxyalkylation.

(7) Polymers with units of following general formula (XXVIII) described for example, in French Patent No. 1 400 366:

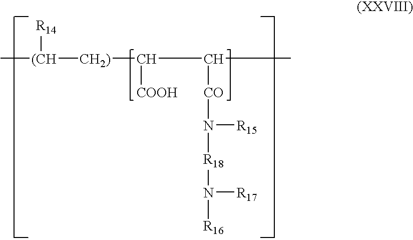

wherein R14 is chosen from a hydrogen atom, CH30, CH3CH₂O, and a phenyl group; R15 is hydrogen or a lower alkyl group, such as methyl and ethyl; R16 is hydrogen or a lower alkyl group, such as methyl and ethyl; R17 is a lower alkyl group, such as methyl and ethyl or a group of following formula: —R18—N(R16)₂, wherein R18 is a —CH2-CH2-, —CH2-CH2-CH2- or —CH2-CH(CH3)- group, and R16 is hydrogen or a lower alkyl group, as well as higher homologues of these groups and comprising up to 6 carbon atoms.

(8) Amphoteric polymers of the -D-X-D-X- type chosen from:

a) polymers obtained by reacting chloracetic acid or sodium chloracetate with compounds comprising at least one unit of formula:

-D-X″-D-X″-D- (XXIX)

wherein D is a group

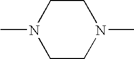

and X″ is the symbol E or E′, wherein E or E′, which may be identical or different, is a bivalent group, which is a straight or branched chain alkylene group comprising up to 7 carbon atoms in the main chain optionally substituted with hydroxyl groups, that may moreover comprise oxygen, nitrogen, or sulfur atoms, from 1 to 3 aromatic and/or heterocyclic rings; oxygen, nitrogen and sulfur atoms in the form of ether, thioether, sulfoxide, sulfone, sulfonium, alkyl amine, alkenyl amine groups, hydroxyl, benzylamine, amine oxide, quaternary ammonium, amide, imide, alcohol, ester and/or urethane groups.

b) Polymers of formula:

-D-X″-D-X″- (XXX)

wherein D is a group

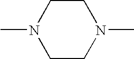

and X″ is the symbol E or E′ and at least one time E′; E being as previously defined and E′ is a bivalent group which is a straight or branched chain alkylene group having up to 7 carbon atoms in the main chain, optionally substituted by at least one hydroxyl group and comprising at least one nitrogen atom, said nitrogen atom being substituted with an alkyl chain optionally interrupted by an oxygen atom and comprising at least one carboxyl function or at least one hydroxyl function that were betainized by reacting with chloracetic acid or sodium chloracetate.

(9) Copolymers of alkyl(C₁-C₅)vinylether and maleic anhydride partially modified by half-amidification with a N,N-dialkylaminoalkyl amine, such as N,N-dimethylaminopropyl amine or by half-esterification with a N,N-dialkanol amine. These copolymers may also comprise other vinyl comonomers, such as vinyl caprolactame.

According to at least one embodiment of the present disclosure, fixing amphoteric polymers to be used in the method may be chosen from the group comprising branched, block copolymers comprising:

(a) non ionic units derived from at least one monomer chosen from C₁-C₂₀ alkyl (meth)acrylates, N-mono-(C₂-C₁₂ alkyl)-(meth)acrylamides and N,N-di-(C₂-C₁₂ alkyl)-(meth)acrylamide,

(b) anionic units derived from at least one monomer chosen from acrylic acid and methacrylic acid, and

(c) polyfunctional units derived from at least one monomer comprising at least two unsaturated polymerizable functional groups,

and having in at least one embodiment, a structure formed from hydrophobic blocks onto which several more hydrophilic blocks are fixed through polyfunctional units (c).

In at least one embodiment of the present disclosure, amphoteric polymers present at least two glass transition temperatures (Tg), one of which is higher than 20° C. and the other lower than 20° C.

In another embodiment, amphoteric polymers are polymers comprising units derived:

a) from at least one monomer chosen from acrylamides or methacrylamides substituted on the nitrogen atom by an alkyl group,

b) from at least one acidic comonomer comprising at least one reactive carboxylic group, and

c) from at least one basic comonomer, such as primary, secondary, tertiary and quaternary amine substituent esters of acrylic and methacrylic acids, and the quaternization product of dimethylaminoethyl methacrylate with dimethyl or diethyl sulfate. Suitable examples include, but are not limited to polymers marketed under the name AMPHOMER by NATIONAL STARCH.

The composition medium as disclosed herein comprises the fixing polymer is an aqueous, alcoholic or hydroalcoholic cosmetically acceptable medium. Cosmetically acceptable organic solvents are for example monoalcohols, polyols or ethers of alcohols or polyols such as ethanol, isopropanol, glycerol, propylene glycol, propylene glycol and monomethyl ether. In at least one embodiment, ethanol is the organic solvent. In at least one embodiment of the present disclosure, the fixing polymer is present in an amount ranging from 0.1 to 20%, for example from 1 to 15% by weight relative to the total weight of the composition. Applying the fixing polymer-containing composition may occur, for example with a spray, i.e., an aerosol device or a pump container dispensing a foam or fine droplets of a solution.

According to at least one embodiment of the present disclosure, the application of the reducing composition and/or the fixing composition occur(s) under heating or is (are) immediately followed with heating.

In at least one embodiment, the method as disclosed herein comprises, following applying the reducing composition, and/or following the oxidation fixing, rinsing the keratin fibers with water.

The reducing composition may also be applied as the hair winding up is being effected. In at least one embodiment, the reducing composition is then allowed to react for a time period ranging from 1 to 50 minutes, for example from 1 to 30 minutes.

It is also possible after having applied the reducing composition, to submit the hair to a thermal treatment by heating to a temperature ranging from 30 to 250° C. for part of or all the reaction time. This operation may be conducted by means of a hood hair dryer, a hair dryer, a round iron or a flat iron, an IR-emitting device and other heating devices, and in some cases under a plastic film.

A rinsing operation of the keratin fibers is then optionally effected with water, and then a drying operation.

The drying may be complete or partial, it may be done for example by means of a domestic hair dryer or a hood hair dryer or a heating hair cap, or be effected by carefully wringing the hair out. In at least one embodiment, a heating system will be used. In at least one embodiment, the drying is complete.

The oxidizing composition that reforms the keratin disulfide bonds is then applied onto the dried or wringed hair, for a reaction time ranging from 2 to 30 minutes. The hair is then rinsed off thoroughly, for instance with water, then the optionally present tensioning materials are removed.

As previously explained, the method as disclosed herein may comprise applying a hair-care composition comprising a cationic polymer and/or a silicone, for example an amine silicone. By way of non-limiting example, the hair-care composition may be applied:

prior to setting the hair under tension,

between the hair tensioning and the application of the reducing composition,

after rinsing with water following the application of the reducing composition and before the oxidation fixing, and/or

after rinsing with water following the oxidation fixing.

In at least one embodiment, the hair-care composition is applied before mechanically setting the keratin fibers under tension.

In another embodiment, the application of the hair-care composition is followed with rinsing, such as a rinsing with water.

After having rinsed off the reducing agent, the hair is dried in form or wringed out and then fixed with the fixing agent.

The permanently reshaping method as disclosed herein, with the provision of a simple intermediary drying step between application of the reducing and oxidizing compositions, thus may make it possible to durably add some texture, weight and body to the hair, to provide stylability, and/or special hair root-volume, for example to short-length and thin hair, for several weeks.

The hair color barely changes immediately after the treatment.

In addition, a protecting effect on artificially colored hair is observed upon repeated washing with shampoos i.e., the method for permanently reshaping the keratin fibers as disclosed herein may lessen or eliminate deterioration of the artificial hair color.

Lastly, the provision in the method of the present disclosure of applying a reducing composition and an oxidizing composition makes it possible to durably reshape the keratin fibers in a way similar to that observed with the usual permanent reshaping methods.

Another aspect of the present disclosure is a kit comprising:

at least one first compartment comprising a reducing composition, such as described above, and

at least one second compartment comprising an oxidizing composition, such as described above.

In at least one embodiment, this kit also comprises means for mechanically setting the hair under tension, such as tulip-type curlers.

Other than in the operating examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should be construed in light of the number of significant digits and ordinary rounding approaches.

Notwithstanding the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in its respective testing measurement.

The examples that follow are intended to illustrate the present disclosure without being limiting in nature.

### EXAMPLE 1

A reducing composition and an oxidizing composition were prepared to implement a method for permanently reshaping the hair according to the invention.

Formulations were as follows:

### COMPOSITION EXAMPLE

In the following composition examples, percentages are expressed by weight relative to the total weight of the composition.

### Reducing Composition (1):

| | |
|---|---|
| Cysteine | 2% |
| Ammonium thioglycolate in | 0.7% |
| 71% aqueous solution | |
| Monoethanol amine | 1.4% |
| Ammonium bicarbonate | 1.3% |
| Sodium cocoamphopropionate | 0.7% |
| Mexomer PO (60% active material) | 0.8% |
| Demineralized water | qs 100% |
| pH value 8.8 | |

### Oxidizing Composition (2)

| | |
|---|---|
| 50% Hydrogen peroxide | 2.4% |
| Stabilizers | 0.01% |
| Citric acid | 0.05% |
| Merquat 100 (Polyquaternium 6) | 0.6% |
| Lauramine oxide | 1.1% |
| Demineralized water | qs 100% |
| pH value 3 | |

### Spray Composition (3)

| | |
|---|---|
| LUVISET Si PUR A | 5.13% |
| AQ 48 | 6.15% |
| Alcohol | 28.95% |
| Water | qs 100% |

Aerosol comprising 65 g of composition (3) and 35 g of dimethyl ether propellant.

### Hair-Care Composition 4

| | |
|---|---|
| Wacker Belsil ADM LOG 1 | 10% |
| Water | qs 100% |

### EXAMPLE 2

### Methods for Permanently Reshaping the Hair According to the Invention Procedure with Spray 3

The hair was shampooed and wrung out.

The hair was wound around the tulip-type curlers.

Aerosol composition (3) was generously spread onto the whole hair.

The reducing composition (1) was then applied onto the hair. The composition was allowed to react for 15 minutes, then the hair was rinsed off.

The hair was then dried under a heating hood hair dryer.

The oxidizing composition (2) was then applied.

After 5 minutes, the hair was rinsed and the tulip-type curlers removed.

A lifting could be observed on the roots and the hair appeared more dense.

After several shampoos, these advantages did still persist.

Procedure with Hair-Care Composition 4

The hair was shampooed and wringed out.

The hair-care composition (4) was applied.

The hair was wound around the tulip-type curlers.

The reducing composition (1) was then applied onto the hair. The composition was allowed to react for 15 minutes, then the hair was rinsed off.

The hair was then dried with a hair dryer.

The oxidizing composition (2) was then applied.

After 5 minutes, the hair was rinsed and the tulip-type curlers removed.

A lifting could be observed on the roots and the hair appeared more dense.

After several shampoos, these advantages did still persist.

What is claimed is:

1. A method for permanently reshaping the keratin fibers, comprising:
setting the keratin fibers under tension, then
applying a reducing composition onto the keratin fibers so as to reduce the keratin disulfide bonds, said reducing composition comprising in a cosmetically acceptable medium, from 0.1 to 3% by weight of at least one reducing agent, relative to the total weight of the reducing composition, then, after an optional rinsing,
drying the keratin fibers, then
oxidation fixing, so as to reform said bonds, by applying an oxidizing composition onto the keratin fibers.

2. The method according to claim 1, wherein the keratin fiber drying is a partial drying or a complete drying.

3. The method according to claim 1, wherein the keratin fiber drying is a complete drying.

4. The method according to claim 1, comprising setting the keratin fibers under tension with tulip-type curlers.

5. The method according to claim 1, wherein the at least one reducing agent is chosen from sulfites, bisulfites, thiols and phosphines.

6. The method according to claim 1, wherein the at least reducing agent is chosen from L-cysteine, D-cysteine, L,D-cysteine, and their salts, thiolactic acid, salts and esters thereof, thioglycolic acid, salts and esters thereof, and mixtures thereof.

7. The method according to claim 1, wherein the at least one reducing agent is present in an amount ranging from 0.3 to 3% by weight, relative to the total weight of the reducing composition.

8. The method according to claim 1, wherein the reducing composition is allowed to react for 2 to 50 minutes.

9. The method according to claim 1, wherein the pH value of the reducing composition ranges from 7.5 to 11.

10. The method according claim 1, wherein the oxidizing composition comprises at least one oxidizing agent chosen from hydrogen peroxide, carbamide peroxide, alkaline bromates, polythionates, persalts, such as perborates, percarbonates and persulfates.

11. The method according to claim 10, wherein the at least one oxidizing agent is present in an amount ranging from 0.1 to 10%, by weight relative to the total weight of the oxidizing composition.

12. The method according to claim 1, wherein the oxidizing composition is allowed to react for 2 to 30 minutes.

13. The method according to claim 1, wherein the pH value of the oxidizing composition ranges from 1.5 to 4.5.

14. The method according to claim 1, wherein the method comprises, following the application of the reducing composition and/or following the oxidation fixing, rinsing the keratin fibers with water.

15. The method according to claim 1, wherein the application of the reducing composition is effected under heating or is immediately followed with a heating operation.

16. The method according to claim 1, wherein the reducing composition and the oxidizing composition are present independently of each other in the form of a lotion, a thickened or non-thickened gel; a foam, or a cream.

17. The method for permanently reshaping the hair according to claim 1, wherein the keratin fibers are mechanically set under tension after the application of a hair-care composition comprising a cationic polymer and/or a silicone.

18. The method for permanently reshaping the hair according to claim 17, wherein the application of the hair-care composition is followed by rinsing.

19. The method for permanently reshaping the hair according to claim 1, wherein the method further comprises applying a fixing polymer-containing composition to the hair.

20. The method for permanently reshaping the hair according to claim 19, comprising applying the fixing polymer-containing composition after setting the keratin fibers under mechanical tension and before applying the reducing composition.

21. A kit comprising:
at least one first compartment comprising a reducing composition, comprising in a cosmetically acceptable medium, from 0.1 to 3% by weight of at least one reducing agent, relative to the total weight of the reducing composition, and
at least one second compartment comprising an oxidizing composition.

22. The kit according to claim 21, comprising a means for setting the hair under mechanical tension.
